(19) United States
(12) Patent Application Publication
(10) Pub. No.: US 2026/0134725 A1
(43) Pub. Date: May 14, 2026

(54) SYSTEMS AND METHODS FOR INFRASTRUCTURE AND EVENT REPORTING FROM AUTONOMOUS FLEET

(71) Applicant: Torc Robotics, Inc., Blacksburg, VA (US)

(72) Inventors: David John Thompson, Christiansburg, VA (US); Walter Allen Grigg, Buchanan, VA (US); Carly Vickers, Christiansburg, VA (US)

(21) Appl. No.: 18/948,046

(22) Filed: Nov. 14, 2024

(51) Int. Cl. G07C 5/00; G06N 20/00; G07C 5/08

(52) U.S. Cl. CPC G07C 5/008; G06N 20/00; G07C 5/085

(57) ABSTRACT

An event reporting system includes at least one autonomous vehicle where the at least one autonomous vehicle includes an autonomy computing system. At least one processor of the autonomy computing system is programmed to receive sensor data. The at least one processor is also programmed to detect an event is present by evaluating the sensor data. The at least one processor is further programmed to log sensor data related to the event. The event reporting system includes an event reporting server computing system including at least one processor programmed to receive logged sensor data related to the event from the at least one autonomous vehicle. The at least one processor is also programmed to process the logged sensor data and report the event by comparing with a database and sending the event to an external party based on the comparison.

### TECHNICAL FIELD

The field of the disclosure relates generally to autonomous vehicles and, more specifically, managing infrastructure and event information with autonomous vehicles.

### BACKGROUND OF THE INVENTION

Roadway conditions and events are observed by vehicle operators in real time as they travel. Generally, vehicle operators do not report these conditions and events to authorities or other roadway users. Information regarding roadway conditions and events are usually collected through specialized targeted inspections and studies by authorities such as law enforcement and departments of transportation. These attempts to inspect and study roadway conditions and events are often time consuming and expensive and may only provide detailed information on relatively small sections of roadway. Accordingly, it is desirable to improve the detection, logging, and reporting of road events.

This section is intended to introduce the reader to various aspects of art that may be related to various aspects of the present disclosure described or claimed below. This description is believed to be helpful in providing the reader with background information to facilitate a better understanding of the various aspects of the present disclosure. Accordingly, it should be understood that these statements are to be read in this light and not as admissions of prior art.

### SUMMARY OF THE INVENTION

In one aspect, the disclosed includes an event reporting system. The event reporting system includes at least one autonomous vehicle. The at least one autonomous vehicle includes an autonomy computing system. The autonomy computing system includes at least one processor in communication with at least one memory device. The at least one processor is programmed to receive sensor data from one or more sensors of the autonomous vehicle. The at least one processor is also programmed to detect an event is present in an environment in which the autonomous vehicle is traveling though by evaluating the sensor data. The at least one processor is further programmed to log sensor data related to the event. The event reporting system also includes an event reporting server computing system. The event reporting server computing system includes at least one processor in communication with at least one memory device. The at least one processor is programmed to receive logged sensor data related to the event from at least one autonomous vehicle of the fleet of autonomous vehicles. The at least one processor is also programmed to process the logged sensor data related to the event. The at least one processor is further programmed to report the event by comparing the event with a database of existing events and sending the event to an external party based on the comparison

In another aspect the disclosed is a computer-implemented method of event reporting for managing infrastructure and event information. The method includes receiving sensor data from one or more sensors of at least one autonomous vehicle in a fleet of autonomous vehicles. The method also includes detecting an event is present in an environment in which at least one autonomous vehicle is traveling by. Detecting the event includes evaluating the sensor data. The method further includes logging sensor data related to the event, processing the logged sensor data related to the event, and reporting the event. Reporting the event includes comparing the event with a database of existing events and sending the event to an external party based on the comparison.

Various refinements exist of the features noted in relation to the above-mentioned aspects. Further features may also be incorporated in the above-mentioned aspects as well. These refinements and additional features may exist individually or in any combination. For instance, various features discussed below in relation to any of the illustrated examples may be incorporated into any of the above-described aspects, alone or in any combination.

### BRIEF DESCRIPTION OF DRAWINGS

The following drawings form part of the present specification and are included to further demonstrate certain aspects of the present disclosure. The disclosure may be better understood by reference to one or more of these drawings in combination with the detailed description of specific embodiments presented herein.

FIG. 1 is a schematic diagram of an autonomous vehicle;

FIG. 2 is a block diagram of an autonomous vehicle;

FIG. 3A is a block diagram of an example event reporting system;

FIG. 3B is a block diagram of an example detection module of the example event reporting system of FIG. 3A;

FIG. 3C is a block diagram of an example logging module of the example event reporting system of FIG. 3A;

FIG. 3D is a block diagram of an example processing module of the example event reporting system of FIG. 3A;

FIG. 3E is a block diagram of an example reporting module of the example event reporting system of FIG. 3A;

FIG. 3F is a block diagram of an example feedback module of the example event reporting system of FIG. 3A;

FIG. 4 a flow chart of an example event reporting method;

FIG. 5A is a block diagram of an example neural network model;

FIG. 5B is a block diagram of a neuron in the neural network model shown in FIG. 5A;

FIG. 6 is a block diagram of an example computing device; and

FIG. 7 is a block diagram of an example server computing device.

Corresponding reference characters indicate corresponding parts throughout the several views of the drawings. Although specific features of various examples may be shown in some drawings and not in others, this is for convenience only. Any feature of any drawing may be referenced or claimed in combination with any feature of any other drawing. The drawings are not to scale unless otherwise noted.

### DETAILED DESCRIPTION

The following detailed description and examples set forth preferred materials, components, and procedures used in accordance with the present disclosure. This description and these examples, however, are provided by way of illustration only, and nothing therein shall be deemed to be a limitation upon the overall scope of the present disclosure.

The disclosed systems and methods are described, for clarity, using certain terminology when referring to and describing relevant components within the disclosure. Where possible, common industry terminology is employed in a manner consistent with its accepted meaning. Unless otherwise stated, such terminology should be given a broad interpretation consistent with the context of the present application and the scope of the appended claims.

Many individuals and organizations are interested in being informed of roadway conditions and events. Examples include departments of transportation, law enforcement, and roadway travelers as well as others. Much of the information pertaining to roadway conditions and events is acquired through roadway patrol or isolated inspections by use of specialized equipment. These methods are time consuming, expensive, and generally are only able to gather detailed information about relatively small sections of roadway for limited time periods. Because of these constraints and others, individual sections of roadways may only be infrequently inspected or neglected. Furthermore, much of the information gathered is not published or shared with other parties leading to multiple isolated attempts at obtaining the same information.

Autonomous vehicles use a multitude of sensors to facilitate motion planning, navigation, and operation. Much of the information relevant to the individuals and organizations interested in roadway conditions and events may be collected through the standard sensors of an autonomous vehicle. Additionally, some autonomous vehicles are also capable of traversing large swaths of roadway in short periods of time as a byproduct of carrying out missions unrelated to monitoring or reporting roadway conditions and events. There exists an opportunity for managing infrastructure and event information based on the autonomous vehicle data collected during operation while carrying out missions. An autonomous vehicle is described herein as an example for illustration purposes only. Systems and methods described herein may be applied to other machines equipped with at least one sensor, such as robots.

The present application is directed to systems and methods for infrastructure and event reporting to address a long-felt need of roadway information gathering and reporting. This is accomplished by using a fleet of autonomous vehicles to monitor infrastructure and/or road conditions and using a reporting machine learning model to report events and data collected by the fleet of autonomous vehicles to external parties. Feedback from the external parties may be used as ground truth information for training the reporting machine learning model. Increase in the accuracy of event reporting is due to the same or different vehicles in the fleet traversing a same route multiple times. Detection and reporting are performed by separate computing systems, where detecting is performed on the autonomous vehicle while analyzing and reporting the events is performed on an event reporting server computing system separate from the autonomy computing system. The event reporting server computing system provides specific functions of analysis and reporting of the events. This arrangement is advantageous in reducing demand of computation resources on the autonomous vehicle while increasing the accuracy and efficiency in analyzing and reporting events. Using a reporting machine learning model to analyze sensor data related to events and report the events is advantageous in increasing accuracy of the analysis and reporting of the events while including increased varieties of events, compared to analytical approaches. Feedback received from external parties may be used to retrain the reporting machine learning model, thereby increasing the accuracy of the reporting machine learning model.

The system may be configured to identify both discrete events (i.e. potholes and damaged guardrails) and continuous events (i.e. traffic flow measurement), onboard an autonomous vehicle. The event types may be augmented onto existing machine learning models running onboard the autonomous vehicle or may be a separate machine learning model running on the same or different onboard hardware. After detecting an event, relevant data is logged to the vehicle. This may include, for example, lidar point clouds; radar point clouds; camera images; location data; and/or weather information. The data may then be transmitted to an internal database for aggregation with other similar events detected across the autonomous vehicle fleet. A numerical threshold may be used to forward the event, for example, the event is forwarded to external parties after the event is identified more than a threshold number of times. A machine learning model may also be applied to aggregate data to determine accuracy in detection of an event and/or augment the metadata. The event information may be forwarded to external parties through various mechanisms, such as email, remote uploads to an external server, or hosted on an internally hosted dashboard for use by external parties. Using an internally hosted dashboard allows for further feedback from the external parties by flagging incorrect events or even correcting the events that may be used to refine the machine learning model. A dashboard allows for various tools to be created for quantifying the infrastructure defect. For example, a point cloud viewer with measurement tools may be used by an end user to measure the size of a pothole or length of missing guard rails.

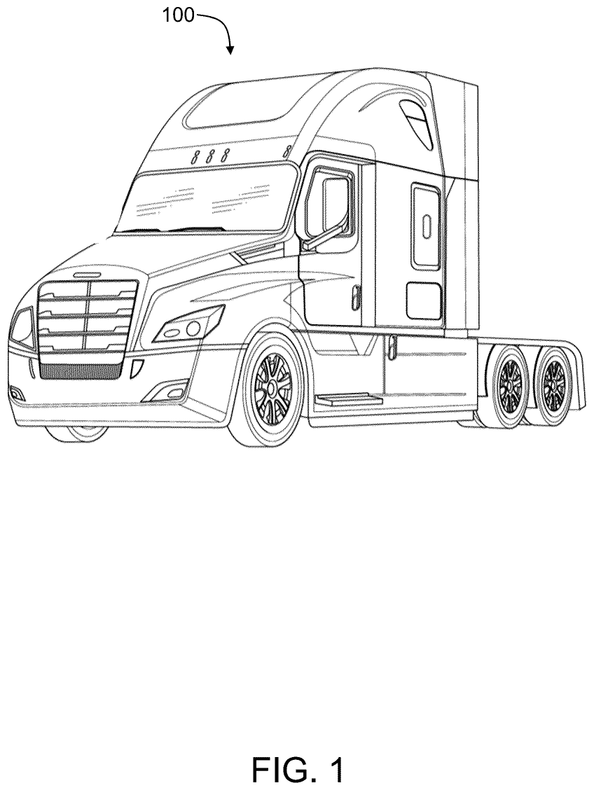

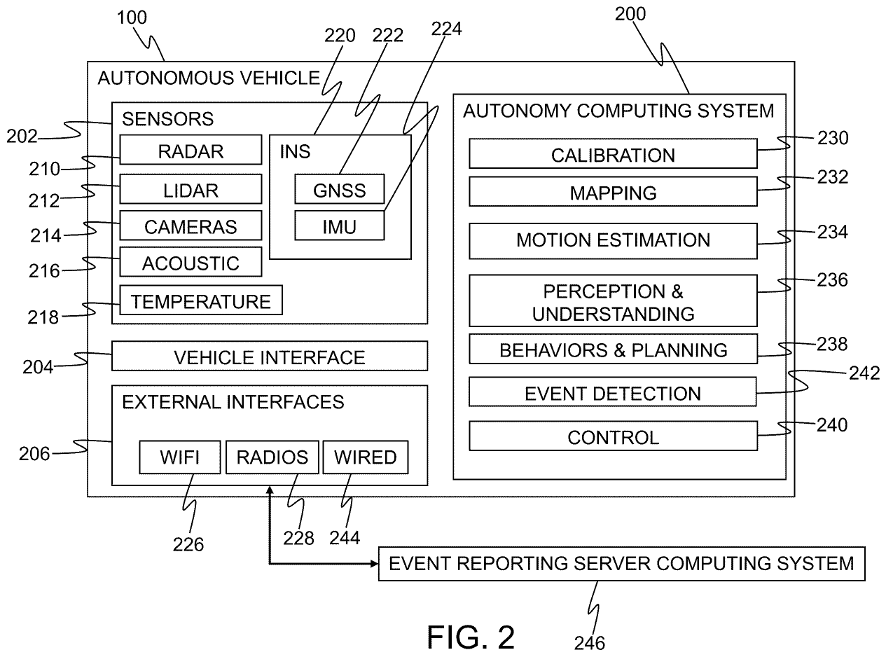

FIG. 1 is a schematic diagram of an autonomous vehicle 100. FIG. 2 is a block diagram of autonomous vehicle 100 shown in FIG. 1. In the example embodiment, autonomous vehicle 100 includes autonomy computing system 200, sensors 202, a vehicle interface 204, and external interfaces 206.

In the example embodiment, sensors 202 may include various sensors such as, for example, radio detection and ranging (RADAR) sensors 210, light detection and ranging (LiDAR) sensors 212, cameras 214, acoustic sensors 216, temperature sensors 218, or inertial navigation system (INS) 220, which may include one or more global navigation satellite system (GNSS) receivers 222 and one or more inertial measurement units (IMU) 224. Other sensors 202 not shown in FIG. 2 may include, for example, acoustic (e.g., ultrasound), internal vehicle sensors, meteorological sensors, or other types of sensors. Sensors 202 generate respective output signals based on detected physical conditions of autonomous vehicle 100 and its proximity. As described in further detail below, these signals may be used by autonomy computing system 120 to determine how to control operation of autonomous vehicle 100.

Cameras 214 are configured to capture images of the environment surrounding autonomous vehicle 100 in any aspect or field of view (FOV). The FOV can have any angle or aspect such that images of the areas ahead of, to the side, behind, above, or below autonomous vehicle 100 may be captured. In some embodiments, the FOV may be limited to particular areas around autonomous vehicle 100 (e.g., forward of autonomous vehicle 100, to the sides of autonomous vehicle 100, etc.) or may surround 360 degrees of autonomous vehicle 100. In some embodiments, autonomous vehicle 100 includes multiple cameras 214, and the images from each of multiple cameras 214 may be stitched or combined to generate a visual representation of the multiple cameras'FOVs, which may be used to, for example, generate a bird's eye view of the environment surrounding autonomous vehicle 100. In some embodiments, the image data generated by cameras 214 may be sent to autonomy computing system 200 or other aspects of autonomous vehicle 100, and this image data may include autonomous vehicle 100 or a generated representation of autonomous vehicle 100. In some embodiments, one or more systems or components of autonomy computing system 200 may overlay labels to the features depicted in the image data, such as on a raster layer or other semantic layer of a high-definition (HD) map.

LiDAR sensors 212 generally include a laser generator and a detector that send and receive a LiDAR signal such that LiDAR point clouds (or “LiDAR images”) of the areas ahead of, to the side, behind, above, or below autonomous vehicle 100 can be captured and represented in the LiDAR point clouds. Radar sensors 210 may include short-range RADAR (SRR), mid-range RADAR (MRR), long-range RADAR (LRR), or ground-penetrating RADAR (GPR). One or more sensors may emit radio waves, and a processor may process received reflected data (e.g., raw radar sensor data) from the emitted radio waves. In some embodiments, the system inputs from cameras 214, radar sensors 210, or LiDAR sensors 212 may be fused or used in combination to determine conditions (e.g., locations of other objects) around autonomous vehicle 100.

GNSS receiver 222 is positioned on autonomous vehicle 100 and may be configured to determine a location of autonomous vehicle 100, which it may embody as GNSS data, as described herein. GNSS receiver 222 may be configured to receive one or more signals from a global navigation satellite system (e.g., Global Positioning System (GPS) constellation) to localize autonomous vehicle 100 via geolocation. In some embodiments, GNSS receiver 222 may provide an input to or be configured to interact with, update, or otherwise utilize one or more digital maps, such as an HD map (e.g., in a raster layer or other semantic map). In some embodiments, GNSS receiver 222 may provide direct velocity measurement via inspection of the Doppler effect on the signal carrier wave. Multiple GNSS receivers 222 may also provide direct measurements of the orientation of autonomous vehicle 100. For example, with two GNSS receivers 222, two attitude angles (e.g., roll and yaw) may be measured or determined. In some embodiments, autonomous vehicle 100 is configured to receive updates from an external network (e.g., a cellular network). The updates may include one or more of position data (e.g., serving as an alternative or supplement to GNSS data), speed/direction data, orientation or attitude data, traffic data, weather data, or other types of data about autonomous vehicle 100 and its environment.

IMU 224 is a micro-electrical-mechanical (MEMS) device that measures and reports one or more features regarding the motion of autonomous vehicle 100, although other implementations are contemplated, such as mechanical, fiber-optic gyro (FOG), or FOG-on-chip (SiFOG) devices. IMU 224 may measure an acceleration, angular rate, and or an orientation of autonomous vehicle 100 or one or more of its individual components using a combination of accelerometers, gyroscopes, or magnetometers. IMU 224 may detect linear acceleration using one or more accelerometers and rotational rate using one or more gyroscopes and attitude information from one or more magnetometers. In some embodiments, IMU 224 may be communicatively coupled to one or more other systems, for example, GNSS receiver 222 and may provide input to and receive output from GNSS receiver 222 such that autonomy computing system 200 is able to determine the motive characteristics (acceleration, speed/direction, orientation/attitude, etc.) of autonomous vehicle 100.

In the example embodiment, autonomy computing system 200 employs vehicle interface 204 to send commands to the various aspects of autonomous vehicle 100 that actually control the motion of autonomous vehicle 100 (e.g., engine, throttle, steering wheel, brakes, etc.) and to receive input data from one or more sensors 202 (e.g., internal sensors). External interfaces 206 are configured to enable autonomous vehicle 100 to communicate with an external network via, for example, a wired or wireless connection, such as Wi-Fi 226 or other radios 228. In embodiments including a wireless connection, the connection may be a wireless communication signal (e.g., Wi-Fi, cellular, LTE, 5g, Bluetooth, etc.).

In some embodiments, external interfaces 206 may be configured to communicate with an external network via a wired connection 244, such as, for example, during testing of autonomous vehicle 100 or when downloading mission data after completion of a trip. The connection(s) may be used to download and install various lines of code in the form of digital files (e.g., HD maps), executable programs (e.g., navigation programs), and other computer-readable code that may be used by autonomous vehicle 100 to navigate or otherwise operate, either autonomously or semi-autonomously. The digital files, executable programs, and other computer readable code may be stored locally or remotely and may be routinely updated (e.g., automatically or manually) via external interfaces 206 or updated on demand. In some embodiments, autonomous vehicle 100 may deploy with all of the data it needs to complete a mission (e.g., perception, localization, and mission planning) and may not utilize a wireless connection or other connection while underway.

In the example embodiment, autonomy computing system 200 is implemented by one or more processors and memory devices of autonomous vehicle 100. Autonomy computing system 200 includes modules, which may be hardware components (e.g., processors or other circuits) or software components (e.g., computer applications or processes executable by autonomy computing system 200), configured to generate outputs, such as control signals, based on inputs received from, for example, sensors 202. These modules may include, for example, a calibration module 230, a mapping module 232, a motion estimation module 234, a perception and understanding module 236, a behaviors and planning module 238, a control module or controller 240, and event detection module 242. Event detection module 242, for example, may be embodied within another module, such as behaviors and planning module 238, or separately. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100.

Event detection module 242 identifies and saves data related to roadway events. Event detection module 242 may include one or more of a detection module 302 and/or a logging module 304. Event detection module 242 receives, for example, data from perception and understanding module 236 and/or from one or more sensors 202 and determines when and/or whether an event has occurred. Event detection module 242 also stores at least a portion of the data received from perception and understanding module 236 and/or from one or more sensors 202. In some embodiments, event detection module 242 further includes a processing module 306. Processing module 306 receives logged data from logging module 304, pulls event metadata, and processes the logged data and pulled metadata such as down sampling and/or compressing.

Autonomy computing system 200 of autonomous vehicle 100 may be completely autonomous (fully autonomous) or semi-autonomous. In one example, autonomy computing system 200 can operate under Level 5 autonomy (e.g., full driving automation), Level 4 autonomy (e.g., high driving automation), or Level 3 autonomy (e.g., conditional driving automation). As used herein the term “autonomous” includes both fully autonomous and semi-autonomous.

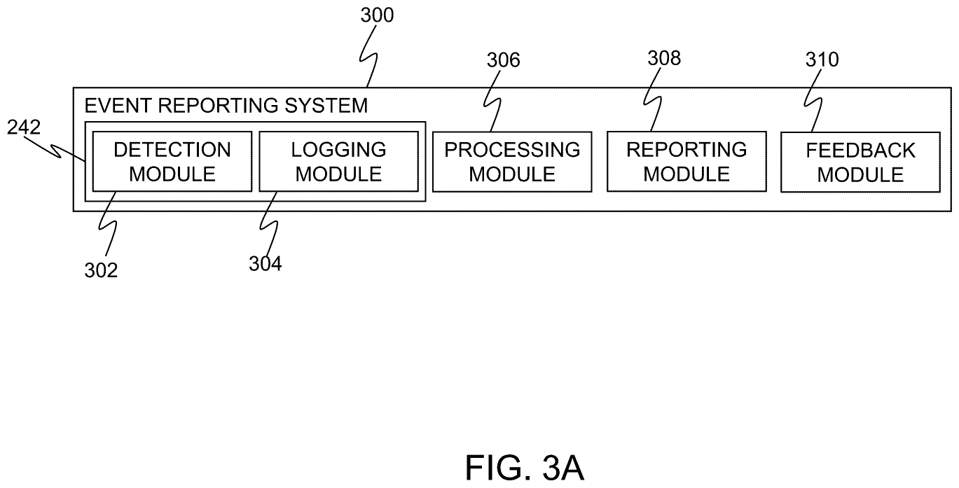

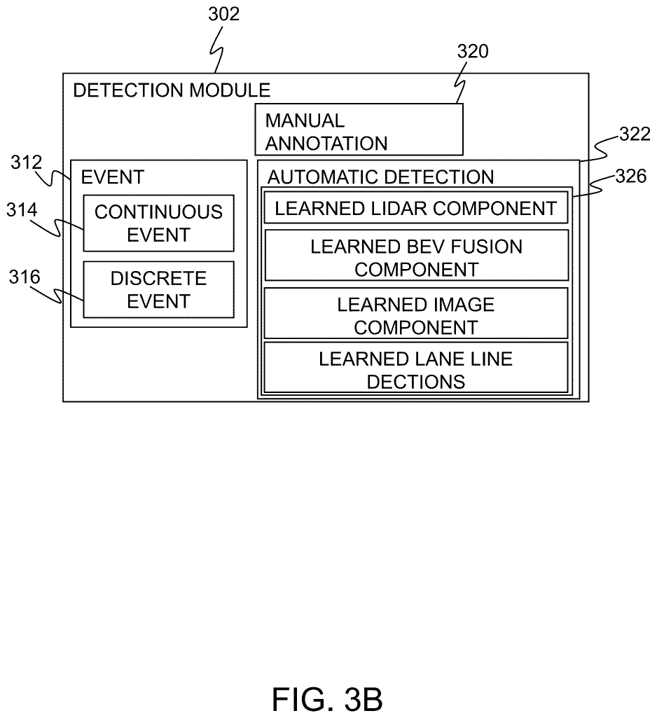

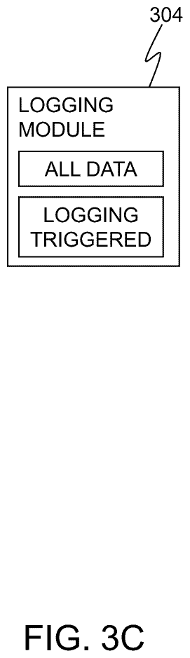

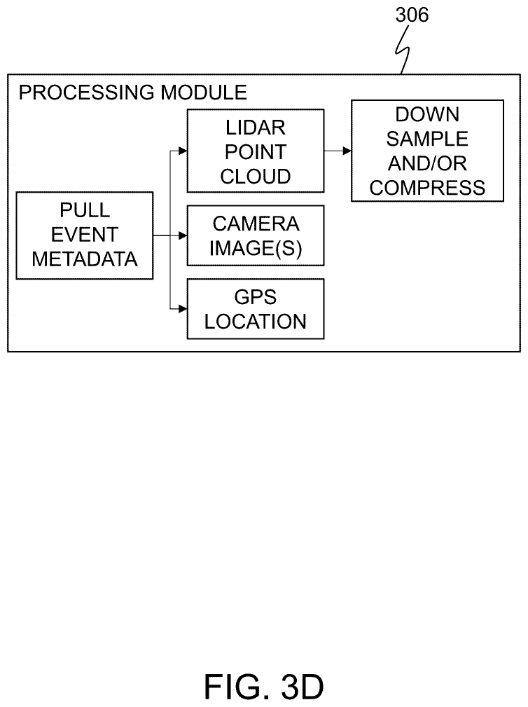

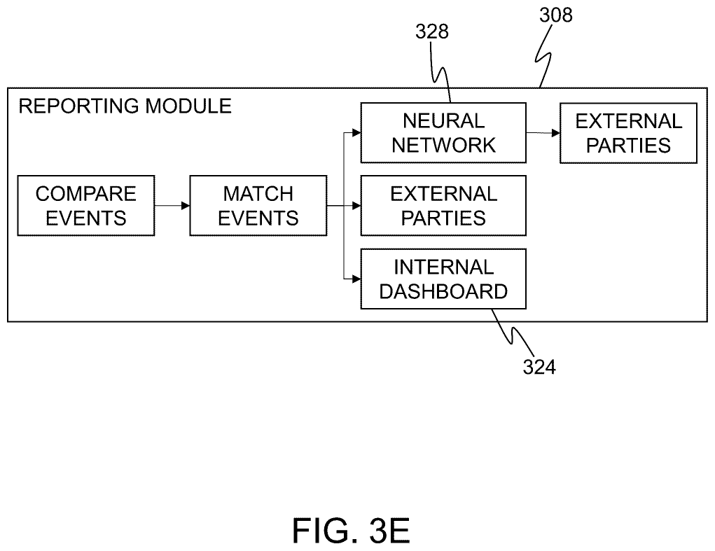

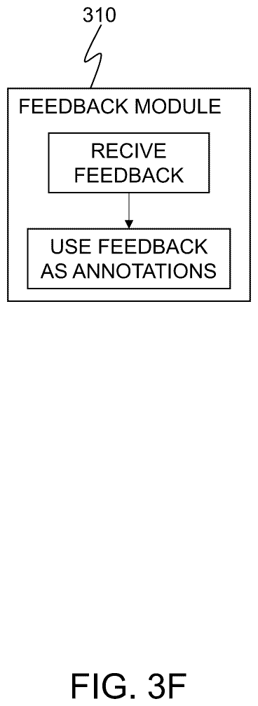

FIG. 3A is a block diagram of an example event reporting system 300. In the example embodiment, event reporting system 300 is implemented by one or more processors and memory devices of one or more autonomous vehicles 100 or a server computer device 700. Example event reporting system 300 includes modules, which may be hardware components (e.g., processors or other circuits) or software components (e.g., computer applications or processes executable by event reporting system 300), configured to process the sensor data and determine events, based on inputs received from, for example, sensors 202. These modules include detection module 302 and a reporting module 308. Event reporting system 300 may further include a logging module 304, a processing module 306, and/or a feedback module 310. These modules may be implemented in dedicated hardware such as, for example, an application specific integrated circuit (ASIC), field programmable gate array (FPGA), or microprocessor, or implemented as executable software modules, or firmware, written to memory and executed on one or more processors onboard autonomous vehicle 100 or an event reporting server computer device 246. For example, event detection module 242 may include one or more detection module 302 and/or logging module 304 onboard autonomous vehicle 100. In some examples, event reporting server computer device 246 may include one or more detection module 302, logging module 304, processing module 306, reporting module 308, and feedback module 310. Event reporting server computing device 246 includes a server computing device, such as a cloud-based computing device. In other embodiments, processing module 306 is included in event detection module 242, and/or split between event detection module 242 and event reporting server computing device 246.

FIG. 3B is a block diagram of an example detection module 302 of example event reporting system 300 shown in FIG. 3A. In the example embodiment, at least one example detection module 302 is included in at least one autonomous vehicle 100. Autonomous vehicle 100 may be in a fleet of autonomous vehicles. Detection module 302 receives sensor data from one or more of sensors 202 of autonomous vehicle 100. Detection module 302 is programmed to discern events 312. An event may be a continuous event 314 or a discrete event 316. As used herein, a continuous event refers to an event related to roadway activity and use that occur at a relatively high frequency. Some non-limiting examples of continuous events 314 include overall traffic flow, traffic flow by lane, speeding vehicles, lazy drivers such as inattentive or unsafe drivers, animals, pedestrians, and roadway conditions such as wear and tear of road surfaces. A discrete event 316 refers to an event related to roadway conditions and damage that occur at a relatively low frequency, compared to a continuous event. Some non-limiting examples of discrete events 316 include infrastructure damage such as potholes and/or damaged guardrails, downed road signs, inoperative roadway lights, road debris, road surface quality such as slippery and/or uneven road surfaces, construction, active work zone, weather conditions, roadkill, standing water, and special situations.

In the example embodiment, example detection module 302 may utilize at least one of manual annotation 320 and automatic detection 322. Manual annotation 320 and automatic detection 322 may be used together and/or separately. Manual annotation 320 involves a human operator reviewing the sensor data from one or more of sensors 202 of autonomous vehicle 100 and identifying when an event 312 has occurred. Manual annotation 320 may be accomplished in real time as autonomous vehicle 100 experiences event 312 conditions or may be accomplished after the fact. Automatic detection 322 may be accomplished through a detection machine learning model 326. Detection machine learning model 326 receives sensor data from one or more of sensors 202 of autonomous vehicle 100 and identifies when one or more events 312 has occurred. In depicted embodiments, detection machine learning model 326 includes one or more sub machine learning models, each configured to detect events based on certain sensor data or types of object detection. For example, detection machine learning model 326 includes a learned LiDAR component configured to detect events based on LiDAR data. Detection machine learning model 326 may include a learned image component configured to detect events based on image data, such as images from cameras 214. Detection machine learning model 326 may also include a learned bird's eye view (BEV) fusion component based on fused data from a plurality of modalities, such as fused data from multiple modalities like cameras and LiDAR, in the BEV. Alternatively or additionally, detection machine learning model 326 includes a learned lane line detection component configured to detect events based on detected lane lines. In one example, events manually annotated are used as ground truth in training and testing detection machine learning model 326.

FIG. 3C is a block diagram of an example logging module 304 of event reporting system 300 shown in FIG. 3A. In the example embodiment, logging module 304 may be included in at least one autonomous vehicle 100. Example logging module 304 is notified from detection module 302 when at least one event 312 has occurred. Example detection module 302 may also notify logging module 304 of the type and duration of event 312. In some embodiments, logging is automatically triggered by the event. For example, logging period of data and/or metadata associated the event is triggered by detection of the event. Logging module 304 may save the sensor data from one or more of sensors 202 related to event 312. The sensor data may include, but is not limited to, LiDAR point clouds, radar point clouds, camera images, location data, and weather information. In some embodiments, logging module 304 may label the saved data based on the information received from detection module 302.

In some embodiments, logging module 304 logs all data collected during a mission of autonomous vehicle 100. Logging module 304 may label the collected data by events 312 identified by detection module 302.

In some embodiments, logging module 304 may only log a portion of data collected during a mission of autonomous vehicle 100. For example, detection module 302 notifies logging module 304 when an event has occurred. Example logging module 304 logs all or some of the sensor data from shortly prior to the time the event was detected to shortly after the event can be detected by the detection module 302. Example logging module 304 may log different sensor data from one or more of sensors 202 depending on the event detected.

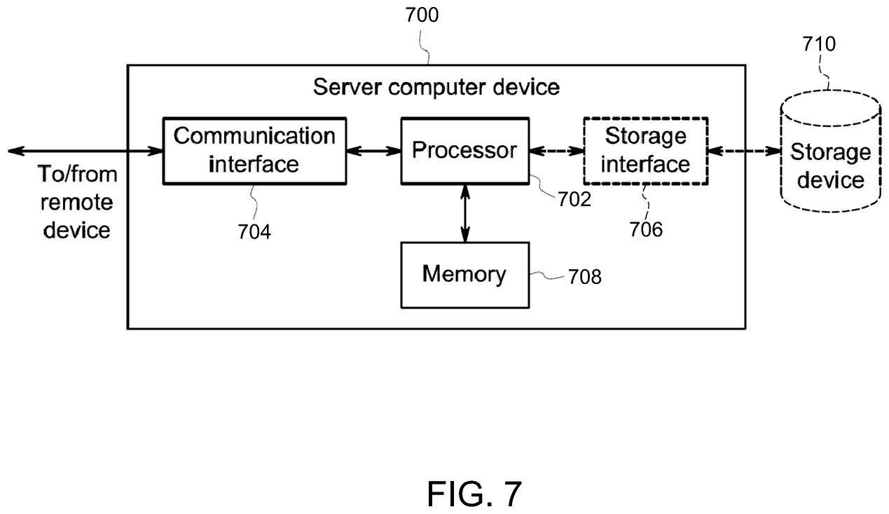

FIG. 3D is a block diagram of example processing module 306 of example event reporting system 300 shown in FIG. 3A. At least one processing module 306 may be included in one or more autonomous vehicle 100 and/or in a server computer device 700 as shown in FIG. 7 (described later). In the example embodiment, example processing module 306 receives logged data from example logging module 304. Processing module 306 may pull metadata from the received logged data. The metadata pulled by processing module 306 include LiDAR point cloud associated with the event, images from sensors such as cameras 214, and/or locations of autonomous vehicle 100 and/or the event such as GPS locations of autonomous vehicle 100 and/or the event. The metadata may further include date logged, time logged, file size, sensor ID, sensor type, vehicle ID, duration, event type, and more.

In the example embodiment, processing module 306 may down sample and/or compress the received logged data, reducing the amount of data for analysis, storage, and/or processing. This is done by systematically selecting a subset of the data at a lower rate than the original. For example, processing module 306 down samples the LiDAR point cloud data by reducing the density of points stored.

In the example embodiment, event processing reduces data storage requirements and allows for faster data transfer. Event processing also allow the logged data to be sorted and organized by metadata for quicker, increasing the speed in accessing later by other modules.

FIG. 3E is a block diagram of example reporting module 308 of event reporting system 300 shown in FIG. 3A. In the example embodiment, at least one reporting module 308 may be included in one or more server computer device 700. Reporting module 308 receives processed data from processing module 306. Reporting module 308 aggregates the processed data with other similar events detected across the autonomous vehicle fleet. Aggregating the processed data includes comparing newly received processed data from processing module 306 to a database of events and matching events based on events metadata. Once the processed data has been aggregated, external parties may be notified of an events occurrence.

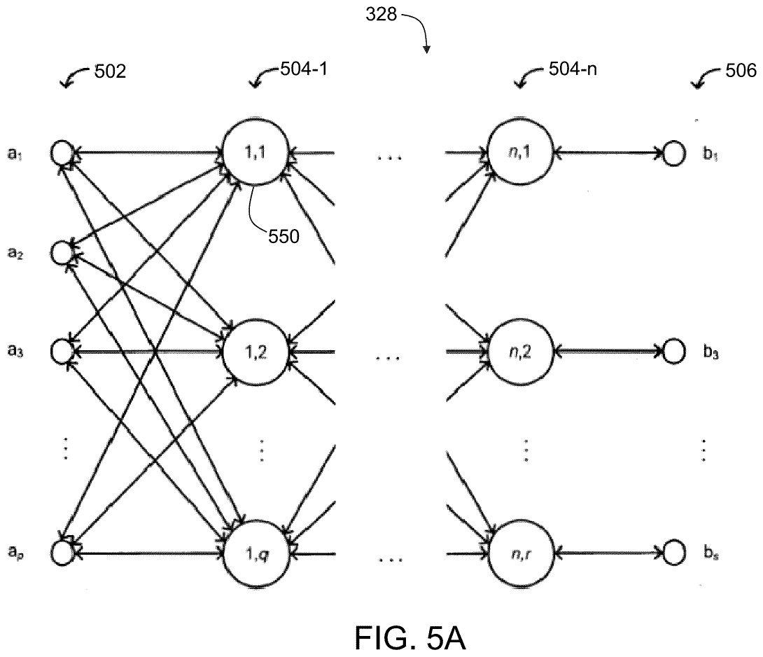

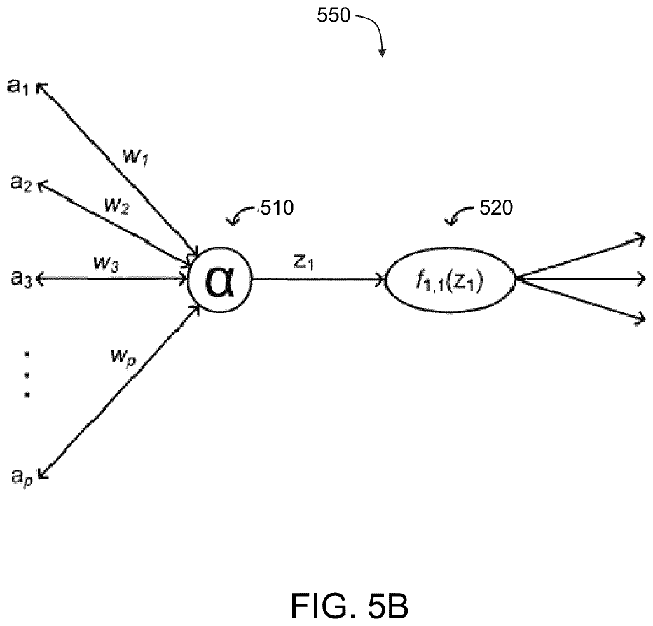

In some embodiments aggregating the processed data may be accomplished through an artificial neural network model 328 as shown in FIGS. 5A and 5B (described later). Newly received processed data from processing module 306 may be used to train or tune the machine learning model throughout event reporting system 300. Neural network model 328 may be offline, where neural network model 328 is not in communication with other computing devices, such as autonomy computing system 200. Alternatively, neural network model 328 is online, where neural network model 328 is in communication with other computing devices and may be updated or retrained as additional events and event data are received. Aggregating the processed data may also be accomplished manually.

In the example embodiment, events occurrence is published to an internal dashboard 324, which may be accessible to external parties and/or accessible internally. Additionally or alternatively, events occurrence is sent directly to external parties. For example, events occurrence may be sent to external parties via email, remote upload to an external server, or other wired or wireless communication pathways. In some embodiments, the events occurrence may only be published to internal dashboard 324 or sent directly to external parties.

In some embodiments a confidence level is used to determine whether to send the event to external parties. The confidence level is provided by artificial neural network model 328, which is the confidence level or confidence score associated with the detected event by the neural network model 328. The confidence level is compared with a predefined threshold. When the confidence level is at or above the predefined threshold, the event is sent to external parties. For example, if the predefined threshold is set as 90%, an event detected with a confidence level at or greater than 90% is sent to external parties. In other embodiments, whether to send the event to external parties is determined based on the number of times the event occurs. For example, the event is sent to external parties when N or more times the event occurs, where N is a predefined threshold.

In some embodiments, dashboard 324 includes tools for quantifying road conditions, such as infrastructure defects. Tools may include a point cloud viewer or other 3D model viewer with measurement tools that may be used, for example, by an external party to measure the size of a pothole or length of missing guard rails. Additionally or alternatively, the quantifying information may be measured in reporting module 308 and provided to external parties. In one example, road conditions are provided by neural network model 328, where neural network model 328 predicts the measurements of the road conditions in the detected event. With this quantified information associated with road conditions, external parties may determine the approximate time and materials required to complete potential repairs.

FIG. 3F is a block diagram of an example feedback module 310 of example event reporting system 300 of FIG. 3A. In the example embodiment, at least one feedback module 310 may be included in one or more server computer device 700. Example feedback module 310 may utilize internally hosted dashboard 324 to allow external parties to provide feedback on the aggregated event data. This feedback may include flagging incorrect events or correcting events. This feedback may then be used to refine the machine learning models of example reporting system 300. For example, if an external party is notified of an event occurrence, but no such event actually occurred, the external party may inform the feedback module 310. Feedback module 310 may then use this information to train and tune neural network model 328. In some embodiments, one or more server computer device 700 is programmed to label the feedback as ground truth of the event. Feedback module 310 may then use this information to train and tune neural network model 328 based on training data including the ground truth.

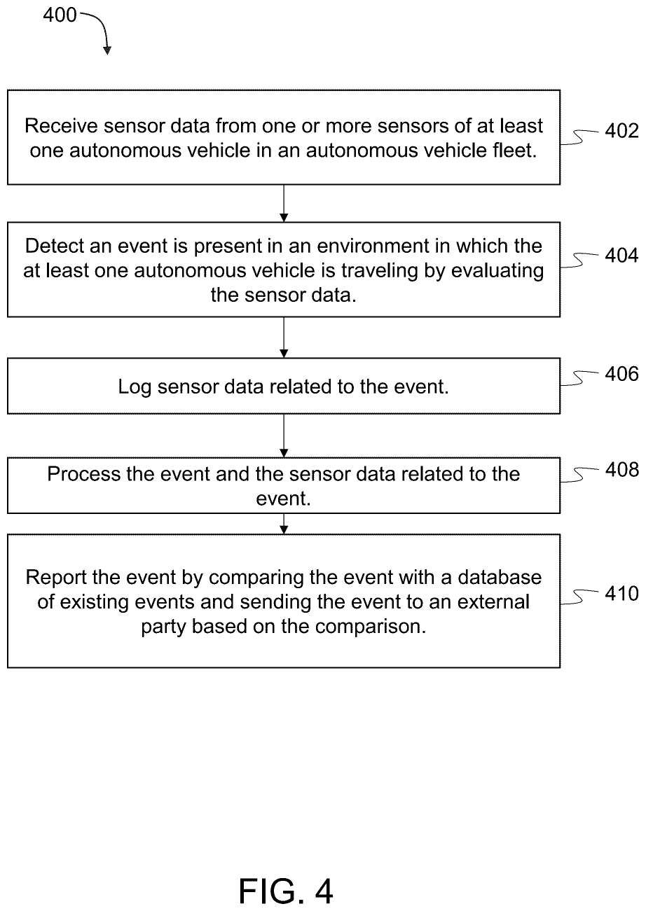

FIG. 4 is a flow chart of an example method 400 of event reporting. Part or all elements of method 400 may be implemented by autonomy computing system 200 of autonomous vehicle 100 and/or server computer device 700. In the example embodiment, method 400 includes receiving 402 sensor data from one or more sensors 202 of at least one autonomous vehicle 100 in a fleet of autonomous vehicles. Method 400 also includes detecting 404 an event is present in an environment in which at least one autonomous vehicle 100 is traveling by evaluating the sensor data. Method 400 further includes logging 406 sensor data related to event 312. Additionally, method 400 includes processing 408 event 312 and the sensor data related to event 312. Method 400 also includes reporting 410 event 312 by comparing the event with a database of existing events and sending the event to an external party based on the comparison.

FIG. 5A depicts an example artificial neural network model 328. The example neural network model 328 includes layers of neurons 502, 504-1 to 504-n, and 506, including an input layer 502, one or more hidden layers 504-1 through 504-n, and an output layer 506. Each layer may include any number of neurons, i.e., q, r, and n in FIG. 5A may be any positive integer. It should be understood that neural networks of a different structure and configuration from that depicted in FIG. 5A may be used to achieve the methods and systems described herein.

In the example embodiment, input layer 502 may receive different input data. For example, input layer 502 includes a first input a1 representing training images, a second input a2 representing patterns identified in the training images, a third input a3 representing edges of the training images, and so on. Input layer 502 may include thousands or more inputs. In some embodiments, the number of elements used by neural network model 328 changes during the training process, and some neurons are bypassed or ignored if, for example, during execution of the neural network, they are determined to be of less relevance.

In the example embodiment, each neuron in hidden layer(s) 504-1 through 504-n processes one or more inputs from input layer 502, and/or one or more outputs from neurons in one of the previous hidden layers, to generate a decision or output. Output layer 506 includes one or more outputs each indicating a label, confidence factor, weight describing the inputs, and/or an output image. In some embodiments, however, outputs of neural network model 328 are obtained from a hidden layer 504-1 through 504-n in addition to, or in place of, output(s) from output layer(s) 506.

In some embodiments, each layer has a discrete, recognizable function with respect to input data. For example, if n is equal to 3, a first layer analyzes the first dimension of the inputs, a second layer the second dimension, and the final layer the third dimension of the inputs. Dimensions may correspond to aspects considered strongly determinative, then those considered of intermediate importance, and finally those of less relevance.

In other embodiments, the layers are not clearly delineated in terms of the functionality they perform. For example, two or more of hidden layers 504-1 through 504-n may share decisions relating to labeling, with no single layer making an independent decision as to labeling.

FIG. 5B depicts an example neuron 550 that corresponds to the neuron labeled as “1,1” in hidden layer 504-1 of FIG. 5A, according to one embodiment. Each of the inputs to neuron 550 (e.g., the inputs in input layer 502 in FIG. 5A) is weighted such that input a1 through ap corresponds to weights w1 through wp as determined during the training process of neural network model 328.

In some embodiments, some inputs lack an explicit weight, or have a weight below a threshold. The weights are applied to a function α (labeled by a reference numeral 510), which may be a summation and may produce a value z1 which is input to a function 520, labeled as f1,1(z1). Function 520 is any suitable linear or non-linear function. As depicted in FIG. 5B, function 520 produces multiple outputs, which may be provided to neuron(s) of a subsequent layer or used as an output of neural network model 328. For example, the outputs may correspond to index values of a list of labels or may be calculated values used as inputs to subsequent functions.

It should be appreciated that the depicted structure and function of neural network model 328 and neuron 550 are for illustration purposes only, and that other suitable configurations exist. For example, the output of any given neuron may depend not only on values determined by past neurons, but also on future neurons.

Neural network model 328 may include a convolutional neural network (CNN), a deep learning neural network, a reinforced or reinforcement learning module or program, or a combined learning module or program that learns in two or more fields or areas of interest. Supervised and unsupervised machine learning techniques may be used. In supervised machine learning, a processing element may be provided with example inputs and their associated outputs and may seek to discover a general rule that maps inputs to outputs, so that when subsequent novel inputs are provided the processing element may, based upon the discovered rule, accurately predict the correct output. Neural network model 328 may be trained using unsupervised machine learning programs. In unsupervised machine learning, the processing element may be required to find its own structure in unlabeled example inputs. Machine learning may involve identifying and recognizing patterns in existing data in order to facilitate making predictions for subsequent data. Models may be created based upon example inputs in order to make valid and reliable predictions for novel inputs.

Additionally, or alternatively, the machine learning programs may be trained by inputting sample data sets or certain data into the programs, such as images, object statistics, and information. The machine learning programs may use deep learning algorithms that may be primarily focused on pattern recognition and may be trained after processing multiple examples. The machine learning programs may include Bayesian Program Learning (BPL), voice recognition and synthesis, image or object recognition, optical character recognition, and/or natural language processing—either individually or in combination. The machine learning programs may also include natural language processing, semantic analysis, automatic reasoning, and/or machine learning.

Based upon these analyses, neural network model 328 may learn how to identify characteristics and patterns that may then be applied to analyzing image data, model data, and/or other data. For example, neural network model 328 may learn to identify features in a series of data points.

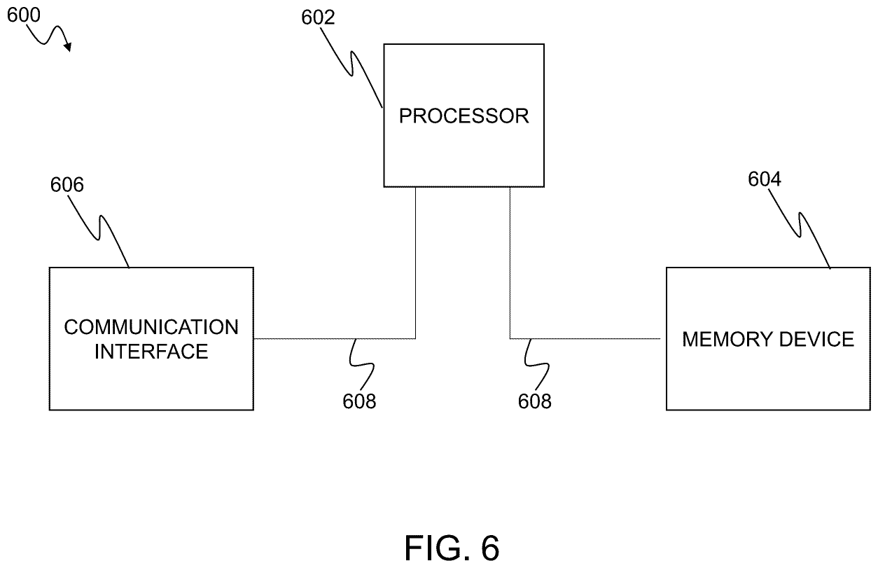

FIG. 6 is a block diagram of an example computing device 600. Autonomy computing system 200 may be implemented with one or more computing devices 600. Computing device 600 includes a processor 602 and a memory device 604. Processor 602 is coupled to memory device 604 via a system bus 608. The term “processor” refers generally to any programmable system including systems and microcontrollers, reduced instruction set computers (RISC), complex instruction set computers (CISC), application specific integrated circuits (ASIC), programmable logic circuits (PLC), and any other circuit or processor capable of executing the functions described herein. The above examples are example only, and thus are not intended to limit in any way the definition or meaning of the term “processor.”

In the example embodiment, memory device 604 includes one or more devices that enable information, such as executable instructions or other data (e.g., sensor data), to be stored and retrieved. Moreover, memory device 604 includes one or more computer readable media, such as, without limitation, dynamic random access memory (DRAM), static random access memory (SRAM), a solid state disk, or a hard disk. In the example embodiment, memory device 604 stores, without limitation, application source code, application object code, configuration data, additional input events, application states, assertion statements, validation results, or any other type of data. Computing device 600, in the example embodiment, may also include a communication interface 606 that is coupled to processor 602 via system bus 608. Moreover, communication interface 606 is communicatively coupled to data acquisition devices.

In the example embodiment, processor 602 may be programmed by encoding an operation using one or more executable instructions and providing the executable instructions in memory device 604. In the example embodiment, processor 602 is programmed to select a plurality of measurements that are received from data acquisition devices.

In operation, a computer executes computer-executable instructions embodied in one or more computer-executable components stored on one or more computer-readable media to implement aspects of the disclosure described or illustrated herein. The order of execution or performance of the operations in embodiments of the disclosure illustrated and described herein is not essential, unless otherwise specified. That is, the operations may be performed in any order, unless otherwise specified, and embodiments of the disclosure may include additional or fewer operations than those disclosed herein. For example, it is contemplated that executing or performing a particular operation before, contemporaneously with, or after another operation is within the scope of aspects of the disclosure.

FIG. 7 is a block diagram of an example server computing device 700. Event reporting server computing system 246 may be implemented with one or more server computing device 700. Server computer device 700 also includes a processor 702 for executing instructions. Instructions may be stored in a memory area 708, for example. Processor 702 may include one or more processing units (e.g., in a multi-core configuration).

Processor 702 is operatively coupled to a communication interface 704 such that server computer device 700 is capable of communicating with a remote device or another server computer device 700. For example, communication interface 704 may receive data from autonomy computing system 200 or sensors 202, via the Internet or wireless communication.

Processor 702 may also be operatively coupled to a storage device 710. Storage device 710 is any computer-operated hardware suitable for storing and/or retrieving data. In some embodiments, storage device 710 is integrated in server computer device 700. For example, server computer device 700 may include one or more hard disk drives as storage device 710. In other embodiments, storage device 710 is external to server computer device 700 and may be accessed by a plurality of server computer devices 700. For example, storage device 710 may include multiple storage units such as hard disks and/or solid-state disks in a redundant array of independent disks (RAID) configuration. Storage device 710 may include a storage area network (SAN) and/or a network attached storage (NAS) system.

In some embodiments, processor 702 is operatively coupled to storage device 710 via a storage interface 706. Storage interface 706 is any component capable of providing processor 702 with access to storage device 710. Storage interface 706 may include, for example, an Advanced Technology Attachment (ATA) adapter, a Serial ATA (SATA) adapter, a Small Computer System Interface (SCSI) adapter, a RAID controller, a SAN adapter, a network adapter, and/or any component providing processor 702 with access to storage device 710.

### Machine Learning

The computer-implemented methods discussed herein may include additional, less, or alternate actions, including those discussed elsewhere herein. The methods may be implemented via one or more local or remote processors, transceivers, and/or sensors (such as processors, transceivers, and/or sensors mounted on mobile devices, or associated with smart infrastructure or remote servers), and/or via computer-executable instructions stored on non-transitory computer-readable media or medium.

Additionally, the computer systems discussed herein may include additional, less, or alternate functionality, including that discussed elsewhere herein. The computer systems discussed herein may include or be implemented via computer-executable instructions stored on non-transitory computer-readable media or medium.

A processor or a processing element may be trained using supervised or unsupervised machine learning, and the machine learning program may employ a neural network, which may be a convolutional neural network, a deep learning neural network, a reinforced or reinforcement learning module or program, or a combined learning module or program that learns in two or more fields or areas of interest. Machine learning may involve identifying and recognizing patterns in existing data in order to facilitate making predictions for subsequent data. Models may be created based upon example inputs in order to make valid and reliable predictions for novel inputs.

Additionally or alternatively, the machine learning programs may be trained by inputting sample (e.g., training) data sets or certain data into the programs, such as conversation data of spoken conversations to be analyzed, mobile device data, and/or additional speech data. The machine learning programs may utilize deep learning algorithms that may be primarily focused on pattern recognition, and may be trained after processing multiple examples. The machine learning programs may include Bayesian program learning (BPL), voice recognition and synthesis, image or object recognition, optical character recognition, and/or natural language processing - either individually or in combination. The machine learning programs may also include natural language processing, semantic analysis, automatic reasoning, and/or other types of machine learning, such as deep learning, reinforced learning, or combined learning.

Supervised and unsupervised machine learning techniques may be used. In supervised machine learning, a processing element may be provided with example inputs and their associated outputs, and may seek to discover a general rule that maps inputs to outputs, so that when subsequent novel inputs are provided the processing element may, based upon the discovered rule, accurately predict the correct output. In unsupervised machine learning, the processing element may be required to find its own structure in unlabeled example inputs. The unsupervised machine learning techniques may include clustering techniques, cluster analysis, anomaly detection techniques, multivariate data analysis, probability techniques, unsupervised quantum learning techniques, associate mining or associate rule mining techniques, and/or the use of neural networks. In some embodiments, semi-supervised learning techniques may be employed. In one embodiment, machine learning techniques may be used to extract data about the conversation, statement, utterance, spoken word, typed word, geolocation data, and/or other data.

An example technical effect of the methods, systems, and apparatus described herein includes at least one of: (a) using a fleet of autonomous vehicles to monitor infrastructure and/or road conditions; (b) using a separate event reporting computing system to handle events and event data from the fleet; (c) using a reporting machine learning model to handle reporting of events; (d) using feedback from an external party as ground truth information for the reporting machine learning model.

Some embodiments involve the use of one or more electronic processing or computing devices. As used herein, the terms “processor” and “computer” and related terms, e.g., “processing device,” and “computing device” are not limited to just those integrated circuits referred to in the art as a computer, but broadly refers to a processor, a processing device or system, a general purpose central processing unit (CPU), a graphics processing unit (GPU), a microcontroller, a microcomputer, a programmable logic controller (PLC), a reduced instruction set computer (RISC) processor, a field programmable gate array (FPGA), a digital signal processor (DSP), an application specific integrated circuit (ASIC), and other programmable circuits or processing devices capable of executing the functions described herein, and these terms are used interchangeably herein. These processing devices are generally “configured” to execute functions by programming or being programmed, or by the provisioning of instructions for execution. The above examples are not intended to limit in any way the definition or meaning of the terms processor, processing device, and related terms.

The various aspects illustrated by logical blocks, modules, circuits, processes, algorithms, and algorithm steps described above may be implemented as electronic hardware, software, or combinations of both. Certain disclosed components, blocks, modules, circuits, and steps are described in terms of their functionality, illustrating the interchangeability of their implementation in electronic hardware or software. The implementation of such functionality varies among different applications given varying system architectures and design constraints. Although such implementations may vary from application to application, they do not constitute a departure from the scope of this disclosure.

Aspects of embodiments implemented in software may be implemented in program code, application software, application programming interfaces (APIs), firmware, middleware, microcode, hardware description languages (HDLs), or any combination thereof. A code segment or machine-executable instruction may represent a procedure, a function, a subprogram, a routine, a subroutine, a module, a software package, a class, or any combination of instructions, data structures, or program statements. A code segment may be coupled to, or integrated with, another code segment or an electronic hardware by passing or receiving information, data, arguments, parameters, memory contents, or memory locations. Information, arguments, parameters, data, etc. may be passed, forwarded, or transmitted via any suitable means including memory sharing, message passing, token passing, network transmission, etc.

The actual software code or specialized control hardware used to implement these systems and methods is not limiting of the claimed features or this disclosure. Thus, the operation and behavior of the systems and methods were described without reference to the specific software code. It is to be understood that software and control hardware can be designed to implement the systems and methods based on the description herein.

When implemented in software, the disclosed functions may be embodied, or stored, as one or more instructions or code on or in memory. In the embodiments described herein, memory includes non-transitory computer-readable media, which may include, but is not limited to, media such as flash memory, a random access memory (RAM), read-only memory (ROM), erasable programmable read-only memory (EPROM), electrically erasable programmable read-only memory (EEPROM), and non-volatile RAM (NVRAM). As used herein, the term “non-transitory computer-readable media” is intended to be representative of any tangible, computer-readable media, including, without limitation, non-transitory computer storage devices, including, without limitation, volatile and non-volatile media, and removable and non-removable media such as a firmware, physical and virtual storage, CD-ROM, DVD, and any other digital source such as a network, a server, cloud system, or the Internet, as well as yet to be developed digital means, with the sole exception being a transitory propagating signal. The methods described herein may be embodied as executable instructions, e.g., “software” and “firmware,” in a non-transitory computer-readable medium. As used herein, the terms “software” and “firmware” are interchangeable and include any computer program stored in memory for execution by personal computers, workstations, clients, and servers. Such instructions, when executed by a processor, configure the processor to perform at least a portion of the disclosed methods.

As used herein, an element or step recited in the singular and proceeded with the word “a” or “an” should be understood as not excluding plural elements or steps unless such exclusion is explicitly recited. Furthermore, references to “one embodiment” of the disclosure or an “exemplary” or “example” embodiment are not intended to be interpreted as excluding the existence of additional embodiments that also incorporate the recited features. Likewise, limitations associated with “one embodiment” or “an embodiment” should not be interpreted as limiting to all embodiments unless explicitly recited.

Disjunctive language such as the phrase “at least one of X, Y, or Z,” unless specifically stated otherwise, is generally intended, within the context presented, to disclose that an item, term, etc. may be either X, Y, or Z, or any combination thereof (e.g., X, Y, and/or Z). Likewise, conjunctive language such as the phrase “at least one of X, Y, and Z,” unless specifically stated otherwise, is generally intended, within the context presented, to disclose at least one of X, at least one of Y, and at least one of Z.

The disclosed systems and methods are not limited to the specific embodiments described herein. Rather, components of the systems or steps of the methods may be utilized independently and separately from other described components or steps.

This written description uses examples to disclose various embodiments, which include the best mode, to enable any person skilled in the art to practice those embodiments, including making and using any devices or systems and performing any incorporated methods. The patentable scope is defined by the claims and may include other examples that occur to those skilled in the art. Such other examples are intended to be within the scope of the claims if they have structural elements that do not differ from the literal language of the claims, or if they include equivalent structural elements with insubstantial differences form the literal language of the claims.

What is claimed is:

1. An event reporting system, comprising:
at least one autonomous vehicle comprising:
an autonomy computing system, comprising at least one processor in communication with at least one memory device, and the at least one processor programmed to:
receive sensor data from one or more sensors of the at least one autonomous vehicle while traveling through an environment;
determine an event is present by evaluating the sensor data; and
log sensor data related to the event; and
an event reporting server computing system, comprising at least one processor in communication with at least one memory device, the at least one processor programmed to;
receive logged sensor data related to the event from the at least one autonomous vehicle;
process the logged sensor data related to the event; and
report the event by:
comparing the event with a database of existing events; and
sending the event to an external party based on the comparison.

2. The event reporting system of claim 1, wherein the event reporting server computing system processor is programmed to process, using a reporting machine learning model, the event and the sensor data related to the event.

3. The event reporting system of claim 2, wherein the event reporting server computing system processor is programmed to send the event to an external party when a confidence level of the reporting machine learning model is at or above a predefined threshold.

4. The event reporting system of claim 3, wherein the event reporting server computing system processor is further programmed to receive feedback from an external party.

5. The event reporting system of claim 1, wherein the at least one autonomous vehicle comprises at least two different autonomous vehicles, and wherein the event reporting server computing system is further programed to receive logged sensor data related to the event from the at least two different autonomous vehicles and compare the event from the at least two different autonomous vehicles.

6. The event reporting system of claim 1, wherein the event reporting server computing system processor is programmed to send the event to an external party when a number of occurrences of the event is at or above a predefined threshold.

7. The event reporting system of claim 1, wherein the autonomy computing system processor is programmed to:
detect the event based on detect one or more continuous events; and
report the processed event by predicting road conditions based on the one or more continuous events.

8. The event reporting system of claim 1, wherein the autonomy computing system processor is programmed to:
detect, using a detection machine learning model, the event is present based on the sensor data.

9. The event reporting system of claim 1, wherein the event reporting server computing system processor is further programmed to pull metadata associated with the event.

10. The event reporting system of claim 9, wherein the event reporting server computing system processor is further programmed to at least one of down sample or compress the sensor data and/or the metadata.

11. A computer-implemented method of event reporting for managing infrastructure and event information, the method comprising:
receiving sensor data from one or more sensors of at least one autonomous vehicle;
detecting an event is present by:
evaluating the sensor data;
logging sensor data related to the event;
processing the logged sensor data related to the event; and
reporting the event by:
comparing the event with a database of existing events; and
sending the event to an external party based on the comparison.

12. The method of claim 11, wherein the processing the event further comprises:
processing, using a reporting machine learning model, the event and the sensor data related to the event.

13. The method of claim 12, wherein the reporting the event further comprises:
sending the event to an external party when a confidence level of the reporting machine learning model is at or above a predefined threshold.

14. The method of claim 13 further comprising:
receiving feedback from an external party.

15. The method of claim 11, wherein the at least one autonomous vehicle comprises at least two different autonomous vehicles, and wherein the reporting the event further comprises:
comparing events detected from the at least two different autonomous vehicles.

16. The method of claim 11, wherein the report the event further comprises:
sending the event to an external party when a number of occurrences of the event is at or above a predefined threshold.

17. The method of claim 11, wherein:
detecting the event further comprises:
detecting one or more continuous events; and
reporting the processed event further comprises:
predicting road conditions based on the one or more continuous events.

18. The method of claim 11, wherein the detecting the event further comprises:
detecting, using a detection machine learning model, the event is present based on the sensor data.

19. The method of claim 11, wherein processing the event further comprises:
pulling metadata associated with the event.

20. The method of claim 19, wherein processing the event further comprises:
at least one of down sampling or compressing the sensor data and/or the metadata.
